(19) United States
(12) Patent Application Publication
(10) Pub. No.: US 2018/0032689 A1
(43) Pub. Date: Feb. 1, 2018

(54) METHOD AND APPARATUS FOR PERFORMING FEATURE CLASSIFICATION ON ELECTROCARDIOGRAM DATA

(71) Applicant: QATAR UNIVERSITY, Doha (QA)

(72) Inventors: Serkan KIRANYAZ, Doha (QA); Turker INCE, Izmir (TR); Moncef GABBOUJ, Tampere (FI); Ridha HAMILA, Doha (QA)

(21) Appl. No.: 15/223,858

(22) Filed: Jul. 29, 2016

(51) Int. Cl. G06F 19/00; G06N 3/08

(52) U.S. Cl. CPC G06F 19/345; G06N 3/08; G06F 19/322

(57) ABSTRACT

A method and apparatus may include receiving patient-specific data of a patient. The method can also include inputting the patient-specific data into an input layer of a 1D convolutional neural network. The method can also include inputting labels corresponding to the patient-specific data into an output layer of the 1D convolutional neural network. The method can also include training the 1D convolutional neural network with the inputted patient-specific data and labels. The 1D convolutional neural network is configured to detect abnormality within patient-specific data.

### BACKGROUND

### Field

Certain embodiments of the present invention relate to performing real-time, patient-specific, feature classification on electrocardiogram data by using neural networks.

### Description of the Related Art

A convolutional neural network (CNN) generally refers to a type of feed-forward artificial neural network. A feed-forward neural network may be considered to be a network where the information is transmitted through the network in a single direction. For example, information may be transmitted to the network via input nodes, through hidden nodes (if applicable), and to output nodes (if applicable). Back propagation is generally considered to be a method of training neural networks where the networks can learn the appropriate internal representations/weights to allow the networks to learn correspondences between inputs and outputs.

### SUMMARY

According to a first embodiment, a method can include receiving patient-specific data of a patient. The method can also include inputting the patient-specific data into an input layer of a 1D convolutional neural network. The method also includes inputting labels corresponding to the patient-specific data into an output layer of the 1D convolutional neural network. The method can also include training the 1D convolutional neural network with the inputted patient-specific data and labels. The 1D convolutional neural network is configured to detect abnormality within patient-specific data.

In the method of the first embodiment, receiving patient-specific data includes receiving electrocardiogram data of the patient.

In the method of the first embodiment, the method can also include processing the received patient-specific data. The processing comprises detecting beats of the electrocardiogram data. The detecting beats includes classifying each beat to a category.

In the method of the first embodiment, configuring the 1D convolutional neural network to detect abnormality includes configuring the 1D convolutional neural network to detect an ectopic beat.

In the method of the first embodiment, the 1D convolution neural network is configured to perform a plurality of back-propagation iterations, and to update weights and bias sensitivities of the 1D convolution neural network for each back-propagation iteration.

In the method of the first embodiment, training the 1D convolutional neural network comprises training using patient-specific data patterns and global data patterns, and the patient-specific data pattern comprises a duration of beats from the patient.

According to a second embodiment, an apparatus can include at least one processor. The apparatus can also include at least one memory including computer program code. The at least one memory and the computer program code can be configured, with the at least one processor, to cause the apparatus at least to receive patient-specific data of a patient. The apparatus can also be caused to input the patient-specific data into an input layer of a 1D convolutional neural network. The apparatus can also input labels corresponding to the patient-specific data into an output layer of the 1D convolutional neural network. The apparatus can also be caused to train the 1D convolutional neural network with the inputted patient-specific data and labels. The 1D convolutional neural network is configured to detect abnormality within patient-specific data.

In the apparatus of the second embodiment, receiving patient-specific data includes receiving electrocardiogram data of the patient.

In the apparatus of the second embodiment, the apparatus is further caused to process the received patient-specific data. The processing includes detecting beats of the electrocardiogram data. The detecting beats includes classifying each beat to a category.

In the apparatus of the second embodiment, configuring the 1D convolutional neural network to detect abnormality includes configuring the 1D convolutional neural network to detect an ectopic beat.

In the apparatus of the second embodiment, the 1D convolution neural network is configured to perform a plurality of back-propagation iterations, and to update weights and bias sensitivities of the 1D convolution neural network for each back-propagation iteration.

In the apparatus of the second embodiment, training the 1D convolutional neural network includes training using patient-specific data patterns and global data patterns, and the patient-specific data pattern includes a duration of beats from the patient.

According to a third embodiment, a computer program can be embodied on a non-transitory computer readable medium. The computer readable medium having instructions stored thereon that, when executed by a computer, causes the computer to perform the method of the first embodiment.

According to a fourth embodiment, a method can include receiving patient-specific data of a patient. The method can also include inputting the patient-specific data to an input layer of a 1D convolutional neural network. The 1D convolutional neural network has been trained. The method can also include detecting an abnormality within the patient-specific data using the trained 1D convolutional neural network.

In the method of the fourth embodiment, receiving patient-specific data includes receiving electrocardiogram data of the patient.

In the method of the fourth embodiment, the method can also include processing the received patient-specific data. The processing includes detecting beats of the electrocardiogram data.

In the method of the fourth embodiment, detecting an abnormality includes detecting an ectopic beat.

In the method of the fourth embodiment, the 1D convolution neural network is configured to perform a plurality of back-propagation iterations, and to update weights and bias sensitivities of the 1D convolution neural network for each back-propagation iteration.

In the method of the fourth embodiment, the 1D convolutional neural network is trained using patient-specific data patterns and global data patterns, and the patient-specific data pattern comprises a duration of beats from the patient.

According to a fifth embodiment, an apparatus can include at least one processor. The apparatus can also include at least one memory including computer program code. The at least one memory and the computer program code can be configured, with the at least one processor, to cause the apparatus at least to receive patient-specific data of a patient. The apparatus can also be caused to input the patient-specific data to an input layer of a 1D convolutional neural network. The 1D convolutional neural network has been trained. The apparatus can also be caused to detect an abnormality within the patient-specific data using the trained 1D convolutional neural network.

In the apparatus of the fifth embodiment, receiving patient-specific data includes receiving electrocardiogram data of the patient.

In the apparatus of the fifth embodiment, the apparatus is further caused to process the received patient-specific data. The processing includes detecting beats of the electrocardiogram data.

In the apparatus of the fifth embodiment, detecting an abnormality includes detecting an ectopic beat.

In the apparatus of the fifth embodiment, the 1D convolution neural network is configured to perform a plurality of back-propagation iterations, and to update weights and bias sensitivities of the 1D convolution neural network for each back-propagation iteration.

In the apparatus of the fifth embodiment, the 1D convolutional neural network is trained using patient-specific data patterns and global data patterns, and the patient-specific data pattern includes a duration of beats from the patient.

According to a sixth embodiment, a computer program can be embodied on a non-transitory computer readable medium, said computer readable medium having instructions stored thereon that, when executed by a computer, causes the computer to perform the method of the fourth embodiment.

### BRIEF DESCRIPTION OF THE DRAWINGS

For proper understanding of the invention, reference should be made to the accompanying drawings, wherein:

FIG. 1 illustrates performing back-propagation training, in accordance with certain embodiments of the present invention.

FIG. 2 illustrates an adaptive 1D CNN implementation, in accordance with certain embodiments of the present invention.

FIG. 3 illustrates a flow of back propagation, in accordance with certain embodiments of the invention.

FIG. 4 illustrates a flowchart of a method in accordance with certain embodiments of the invention.

FIG. 5 illustrates a flowchart of another method in accordance with certain embodiments of the invention.

FIG. 6 illustrates an apparatus in accordance with certain embodiments of the invention.

FIG. 7 illustrates an apparatus in accordance with certain embodiments of the invention.

FIG. 8 illustrates an apparatus in accordance with certain embodiments of the invention.

### DETAILED DESCRIPTION

Certain embodiments of the present invention relate to performing real-time, patient-specific, feature classification on electrocardiogram data by using 1D convolutional neural networks. By using 1D convolutional neural networks, certain embodiments may implement a fast and accurate system for performing patient-specific classification and monitoring of electrocardiogram (ECG) data, as described in more detail below.

Certain embodiments of the present invention use an adaptive implementation of 1D Convolutional Neural Networks (CNNs) that combine two major functions of ECG classification into a single learning body. Specifically, the single learning body can perform both the functions of feature extraction and classification.

With certain embodiments, for each patient with corresponding ECG data, an individual and simple CNN may be trained. The individual and simple CNN can be trained by using a relatively small amount of common training data and patient-specific training data. Upon training the individual and simple CNN to have a patient-specific feature extraction ability, certain embodiments can provide improved classification performance, as described in more detail below.

Certain embodiments can eliminate the need to perform extraction based on manually-configured features. Once a dedicated 1D CNN is trained for a particular patient, the dedicated CNN can be used to perform feature classification on a long ECG data stream in a fast and accurate manner. Certain embodiments can also be used to perform real-time ECG monitoring, and certain embodiments can implement an early-alert system on light-weight wearable devices, as described in more detail below.

The results achieved by certain embodiments of the present invention demonstrate a superior classification performance, as compared to the previous approaches. For example, when certain embodiments are applied to the Massachusetts Institute of Technology—Beth Israel Hospital (MIT-BIH) arrhythmia benchmark database, these embodiments demonstrate superior performance when performing detection of ventricular ectopic beats (VEB) and supraventricular ectopic beats (SVEB), as compared to the previous approaches.

Finally, due to the simple and parameter-invariant nature of certain embodiments, these embodiments can be highly generic and can be applicable to any ECG dataset, as described in more detail below.

The current methods for performing generic and fully-automatic electrocardiogram (ECG) classification use different signal-processing techniques. In general, these current method have not performed well, as a result of variations which exist in ECG data/signals across different patients. As a result of the variations within the ECG data/signals across different patients, the current approaches usually exhibit a common drawback of performing inconsistently when performing feature classification of a new patient's ECG signal, for example. This inconsistent performance of the current approaches makes the current approaches unreliable when they are used widely across different patients, and the current approaches tend to exhibit high variation in their accuracy and efficiency when the current approaches are used on data of larger databases.

As described above, patient-specific ECG classification systems generally use an approach that performs two major operations: (1) feature extraction, and (2) training/classification over the extracted features. These efficacy of the ECG classification is strongly dependent on the characterization power of the features extracted from the ECG data.

The current approaches generally use fixed and manually-configured features to perform ECG classification. However, using the fixed and manually-configured features of the current approaches may not properly represent the characteristics of the underlying ECG signal, and using the fixed and manually-configured features of the current approaches is contrary to the philosophy of a “patient-specific” approach, because a same set of features is used for all patients when using the fixed and manually-configured features of the current approaches.

A truly “patient-specific” solution should have a design that includes the best features for each individual ECG data. Such features should represent the characteristics of the patient's ECG beats in an optimal way and thus yield the highest level of discrimination among the ECG beat categories. However, if the fixed and manually-configured features of the current approaches are not used, then the performing of the extraction of several features (along with the performing of post-processing methods) may significantly increase the computational complexity of the overall process. In particular, performing the extraction of several features in the transform domains can increase the computational complexity. One example of a post-processing method that may increase computational complexity is principal component access (PCA).

This increased amount of computational complexity may render certain extracting/post-processing methods unusable in lightweight applications, and the increased computational complexity may also render certain extracting/post-processing methods unusable for performing classification on large ECG records. Lightweight applications may include mobile applications and/or applications of wearable health-monitoring devices, for example. Large ECG records may include records corresponding to Holter registers, for example.

In order to address the above-described deficiencies and drawbacks, certain embodiments are directed to an ECG classification approach that uses adaptive 1D Convolutional Neural Networks (CNNs), as described above. CNNs are generally considered to be hierarchical neural networks whose convolutional layers alternate with subsampling layers. CNNs may be configured to resemble simple and complex cells of a human visual cortex. CNNs may include fully-connected layers, which may resemble multi-layer perceptrons (MLP).

CNNs may mimic the human visual system, and CNNs can be used to efficiently recognize patterns and structures (e.g., objects) in a visual scenery. CNNs may also be used for “deep learning” tasks, such as object recognition within images contained within large archives.

Certain embodiments may be applied to 1D ECG signals, in particular, for the purpose of performing ECG classification and for performing anomaly detection. As described above, certain embodiments are directed to an adaptation over the traditional CNNs, and certain embodiments of the present invention may allow a user to classify each heart beat (of ECG signals) with any sampling rate, thereby eliminating the need for performing any manual-feature extraction and any post-processing.

With proper training, the convolutional layers of CNNs can learn to extract patient-specific features, while multilayer perceptron (MLP) layers may perform a classification task in order to produce final class vectors for each beat. Each class vector is an n-dimensional vector and has a 1-of-n encoding scheme. Therefore, the location of the positive output, “1”, determines the class of the beat that was the input of the CNN.

Certain embodiments demonstrate that using simple CNNs is generally sufficient for achieving good classification performance. Specifically, certain embodiments demonstrate that using complex CNNs (that are commonly used for deep-learning tasks) is generally unnecessary.

By using simple 1D CNNs, certain embodiments can achieve benefits that generally cannot be achieved when using complex CNNs. For example, simple 1D CNNs are easier to train, as they generally can be trained with only a few dozen back-propagation (BP) epochs. The trained simple 1D CNNs can perform the classification tasks at a high rate (i.e., classification tasks may require only few hundred 1D convolutions).

As described above, the data that is used for training an individual patient's classifier may include, at least, global training patterns (that are common to each patient) and local training patterns (that are patient-specific). The patient-specific data may contain a segment (such as a first five-minute segment) of each patient's ECG record, and can be used as a part of the training data to perform patient adaptation. The global data set contains a relatively small number of representative beats which can be randomly chosen from each class in the training files. With certain embodiments, the global data set can help the classifier to learn arrhythmia patterns that are not included in the patient-specific data.

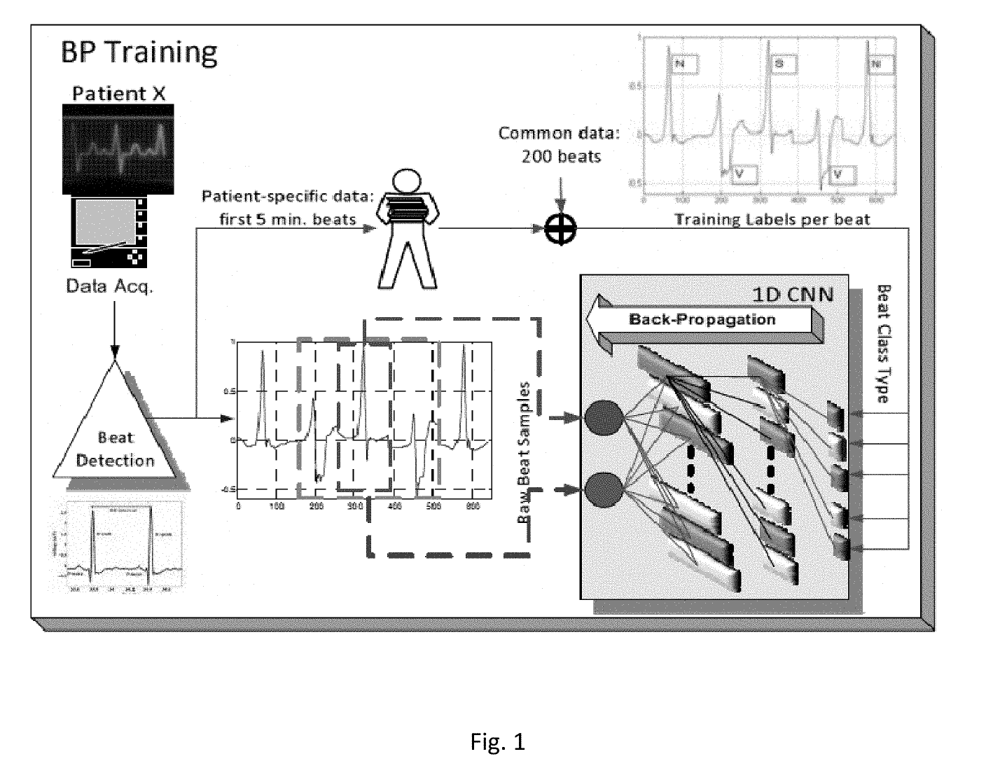

FIG. 1 illustrates performing back-propagation training, in accordance with certain embodiments of the present invention. As illustrated by FIG. 1, ECG data from a patient (such as “Patient X”) can be acquired by a data acquisition device. Next, certain embodiments may perform beat detection on the acquired ECG data. The beat detection process may include classifying each beat to a certain category, for example. With other embodiments, the beat detection process may comprise determining the distinct beats within the ECG data. Next, certain embodiments may input raw beat samples into a 1D CNN. As illustrated by FIG. 1, the 1D CNN can be trained using a combination of both local training patterns (patient-specific data) and global training patterns (common data). The patient-specific data are the ECG beats that were recorded in an earlier time and labeled by Cardiologists. With a larger volume of the patient-specific data, a better generalization performance can be expected to be achieved. On the other hand, the common data may include other patient's labeled beats, which can be included in the training process of CNN, in order to improve the generalization capability of the CNN

With certain embodiments, adaptive 1D CNNs can be used for performing both feature extraction and classification of raw ECG data, for each individual patient in a database.

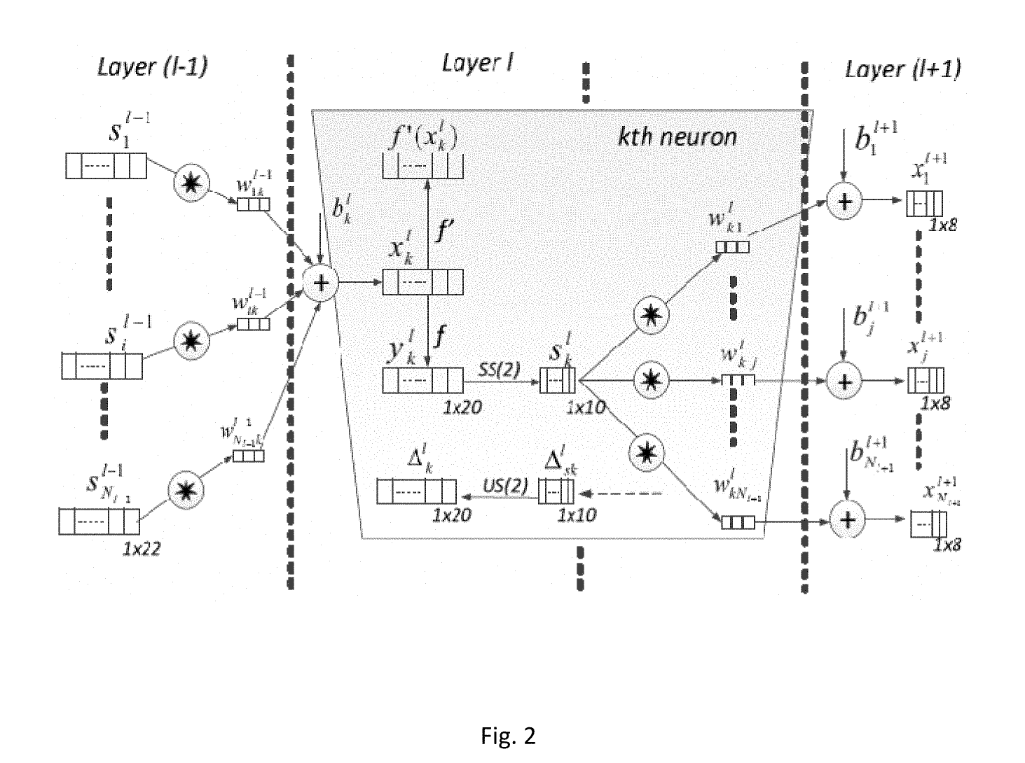

FIG. 2 illustrates an adaptive 1D CNN implementation, in accordance with certain embodiments of the present invention. Neurons of hidden CNN layers can be extended to enable both convolution and subsampling operations, as shown in FIG. 2.

With certain embodiments, 1D forward propagation (FP) can be expressed as:

$${x}_{k}^{l} = {b}_{k}^{l} + {\sum }_{i = 1}^{{N}_{l - 1}} conv 1 D ( {w}_{ik}^{l - 1} , {s}_{i}^{l - 1} ) \qquad ( Equation 1 )$$

Where x^{l}ₖ is the input, b^{l}ₖ is the bias of the kth neuron at layer l, and s^{l-1}ᵢ is the output of the ith neuron at layer l−1. w^{l-1}ᵢₖ is the kernel (weight) from the ith neuron at layer l−1 to the kth neuron at layer l. With such a configuration, the number of hidden CNN layers can be set to any number. Setting the number of hidden CNN layers is possible because the sub-sampling factor of the output CNN layer (the hidden CNN layer just before the first MLP layer) can be set to the dimensions of its input map. For example, in FIG. 2, if layer l+1 is the output CNN layer, then the sub-sampling factors for that layer can be automatically set to ss=8, because the input map dimension is 8 in this example.

Besides the sub-sampling, the dimension of the input maps will gradually decrease due to the convolution without zero padding. In the example of FIG. 2, if the dimension of the neuron output is 22 at the layer l−1, then the dimension is reduced to 20 at layer l. As a result of this reduction, the dimension of the input maps of the current layer is reduced by K−1 where K is the size of the kernel.

With regard to back-propagation (BP) steps, the BP of the error starts from the MLP output layer. Let l=1 and l=L be the input and output layers, respectively. The error in the output layer can be written as:

$$E = E ( {y}_{1}^{L} , … , {y}_{{N}_{L}}^{L} ) = {\sum }_{i = 1}^{{N}_{L}} {( {y}_{i}^{L} - {t}_{i} )}^{2} \qquad ( Equation 2 )$$

For an input vector p, and its corresponding output vector, [y^{L}₁, . . . , y^{L}_{NL}], certain embodiments determine the derivative of this error with respect to an individual weight (connected to that neuron, k) W^{l-1}ik, and a bias of the neuron k, b^{l}ₖ, so that certain embodiments can perform a gradient descent method to minimize the error, accordingly. Once all the delta errors in each MLP layer are determined by the BP, then weights and biases of each neuron can be updated by the gradient descent method.

Specifically, the delta of the kth neuron at layer l, Δ^{l}ₖ, will be used to update the bias of that neuron and all weights of the neurons in the previous layer connected to that neuron, as:

$$\frac{\partial E}{\partial {w}_{ik}^{l - 1}} = {Δ}_{k}^{l} {y}_{i}^{l - 1} and \frac{\partial E}{\partial {b}_{k}^{l}} = {Δ}_{k}^{l} \qquad ( Equation 3 )$$

So, from the input MLP layer to the output CNN layer, the regular (scalar) BP can be simply performed as,

$$\frac{\partial E}{\partial {s}_{k}^{l}} = Δ {s}_{k}^{l} = {\sum }_{i = 1}^{{N}_{l + 1}} \frac{\partial E}{\partial {x}_{i}^{l + 1}} \frac{\partial {x}_{i}^{l + 1}}{\partial {s}_{k}^{l}} = {\sum }_{i = 1}^{{N}_{l + 1}} {Δ}_{i}^{l + 1} {w}_{ki}^{l} \qquad ( Equation 4 )$$

Once the first BP is performed from the next layer, l+1, to the current layer, l, then certain embodiments can further back-propagate it to the input delta, Δ^{l}ₖ. Letting zero order up-sampled map be: us^{l}ₖ=up(Δs^{l}ₖ), then:

$${Δ}_{k}^{l} = \frac{\partial E}{\partial {y}_{k}^{l}} \frac{\partial {y}_{k}^{l}}{\partial {x}_{k}^{l}} = \frac{\partial E}{\partial {us}_{k}^{l}} \frac{\partial {us}_{k}^{l}}{\partial {y}_{k}^{l}} {f}^{′} ( {x}_{k}^{l} ) = up ( Δ {s}_{k}^{l} ) β {f}^{′} ( {x}_{k}^{l} ) \qquad ( Equation 5 )$$

where β=(ss)⁻¹, because each element of s^{l}ₖ was obtained by averaging ss number of elements of the intermediate output, y^{l}ₖ. The inter-BP (among CNN layers) of the delta error

$$Δ {s}_{k}^{l} = {\sum }_{i = 1}^{{N}_{l + 1}} conv 1 Dz ( {Δ}_{i}^{l + 1} , rev ( {w}_{ki}^{l} ) ) \qquad ( Equation 6 )$$

can be expressed as,

$$( ( {Δ}_{k}^{l} {}^{\sum } {Δ}_{i}^{l + 1} ) )$$

where rev(.) reverses the array and conv1Dz(.,.) performs full convolution in 1D with K−1 zero padding. Finally, the weight and bias sensitivities can be expressed as,

$$\frac{\partial E}{\partial {w}_{ki}^{l}} = conv 1 D ( {s}_{k}^{l} , {Δ}_{i}^{l + 1} ) \frac{\partial E}{\partial {b}_{k}^{l}} = {\sum }_{n}^{ } {Δ}_{k}^{l} ( n ) \qquad ( Equation 7 )$$

In view of the above, certain embodiments may use simple CNNs to perform real-time ECG monitoring and to implement an early-alert system on lightweight devices.

Certain embodiments are able to achieve a high level of robust performance, even though variations may exist in the dataset to which the embodiments are applied. Certain embodiments are able to achieve a higher level of robust performance because certain embodiments may be designed with a smaller set of parameters and manual settings. Certain embodiments may use a smaller set of parameters and a smaller set of manual settings because certain embodiments may implement a combined learner for performing feature extraction and for performing classification.

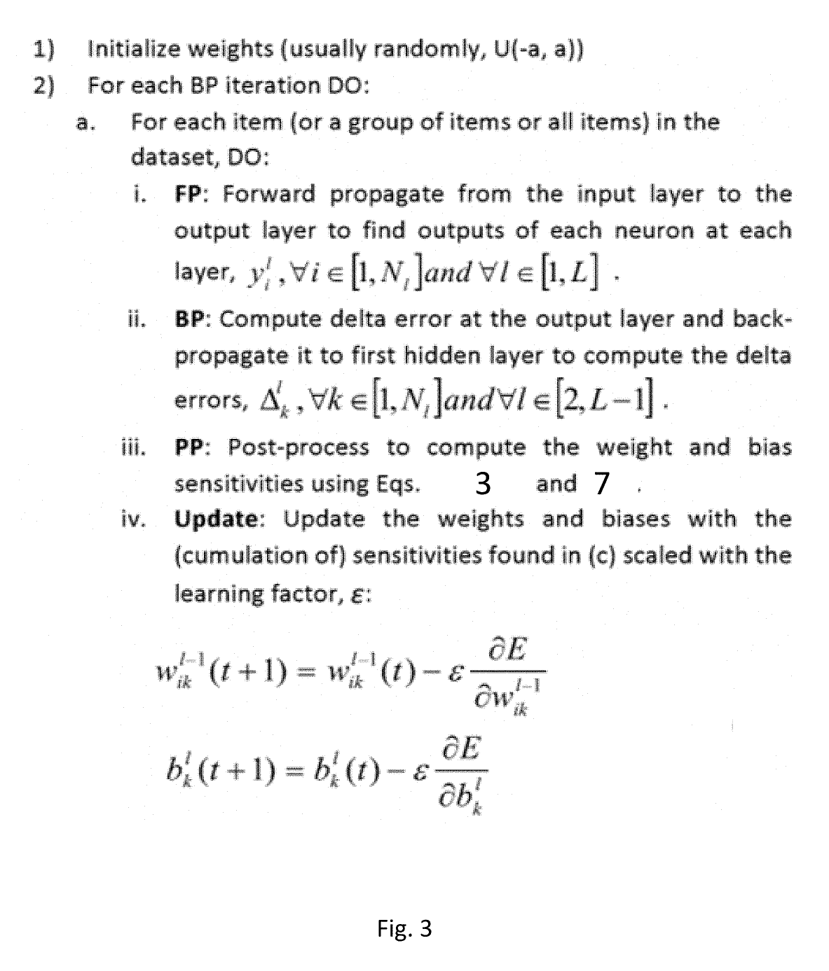

FIG. 3 illustrates a flow of back propagation, in accordance with certain embodiments of the invention. Certain embodiments may forward propagate an input signal, compute delta error at an output layer, compute the weights and biases of the neural network while learning, and update the weights and biases of the neural network.

Certain embodiments of the present invention can be used in personal ECG monitors and personal-computing applications. Certain embodiments can perform as an automated anomaly-detection system and classification system for cardiologists and other experts in the relevant fields.

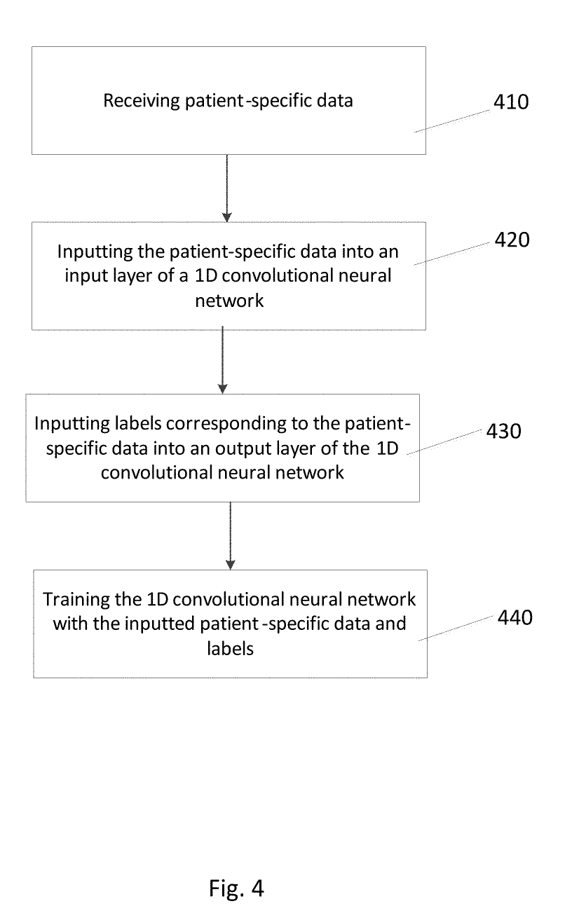

FIG. 4 illustrates a flowchart of a method in accordance with certain embodiments of the invention. The method illustrated in FIG. 4 includes, at 410, receiving patient-specific data of a patient. The method also includes, at 420, inputting the patient-specific data into an input layer of a 1D convolutional neural network. The method also includes, at 430, inputting labels corresponding to the patient-specific data into an output layer of the 1D convolutional neural network. The method also includes, at 440, training the 1D convolutional neural network with the inputted patient-specific data and labels. The 1D convolutional neural network is configured to detect abnormality within patient-specific data.

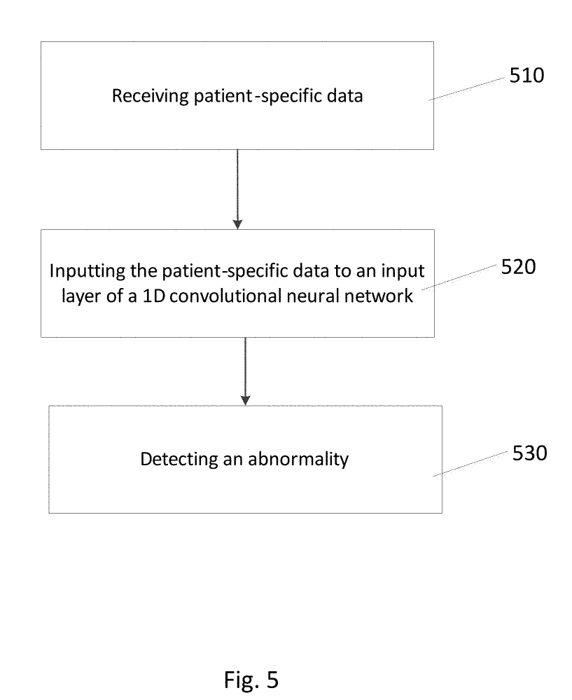

FIG. 5 illustrates a flowchart of a method in accordance with certain embodiments of the invention. The method illustrated in FIG. 5 includes, at 510, receiving patient-specific data of a patient. The method also includes, at 520, inputting the patient-specific data to an input layer of a 1D convolutional neural network. The 1D convolutional neural network has been trained. The method also includes, at 530, detecting an abnormality within the patient-specific data using the trained 1D convolutional neural network.

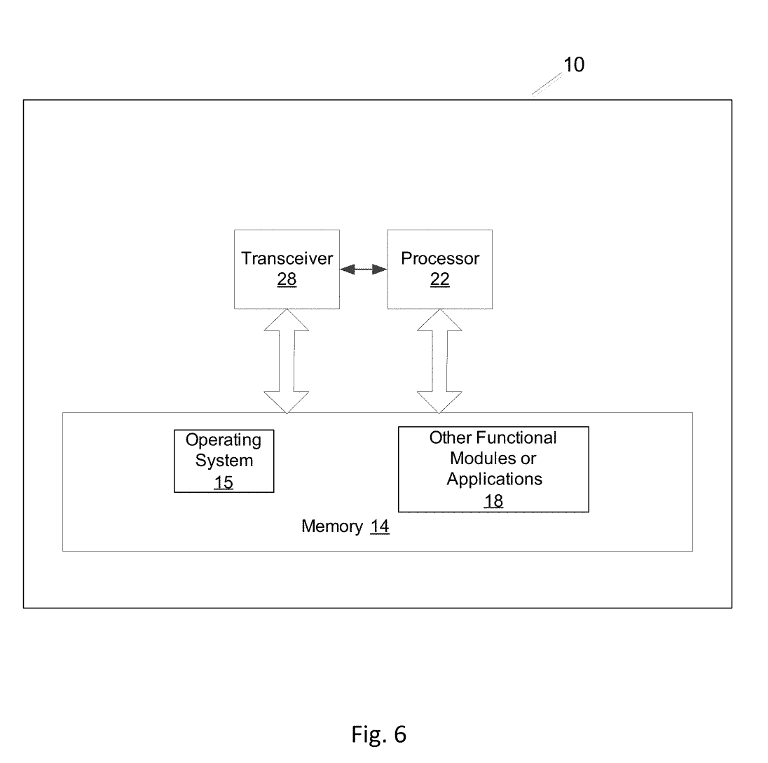

FIG. 6 illustrates an apparatus 10 according to another embodiment. In one embodiment, apparatus 10 may include a neural network that performs motor-fault detection. Apparatus 10 includes a processor 22 for processing information and executing instructions or operations. Processor 22 may be any type of general or specific purpose processor. While a single processor 22 is shown in FIG. 6, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

With certain embodiments, apparatus 10 may be configured to receive patient-specific data of a patient. Apparatus 10 can also be configured to input the patient-specific data into an input layer of a 1D convolutional neural network. Apparatus 10 can also be configured to input labels corresponding to the patient-specific data into an output layer of the 1D convolutional neural network. Apparatus 10 can also be configured to train the 1D convolutional neural network with the inputted patient-specific data and labels. The 1D convolutional neural network is configured to detect abnormality within patient-specific data.

With certain embodiments, apparatus 10 may be configured to receive patient-specific data of a patient. Apparatus 10 can also be configured to input the patient-specific data to an input layer of a 1D convolutional neural network. The 1D convolutional neural network has been trained. Apparatus 10 can also be configured to detect an abnormality within the patient-specific data using the trained 1D convolutional neural network.

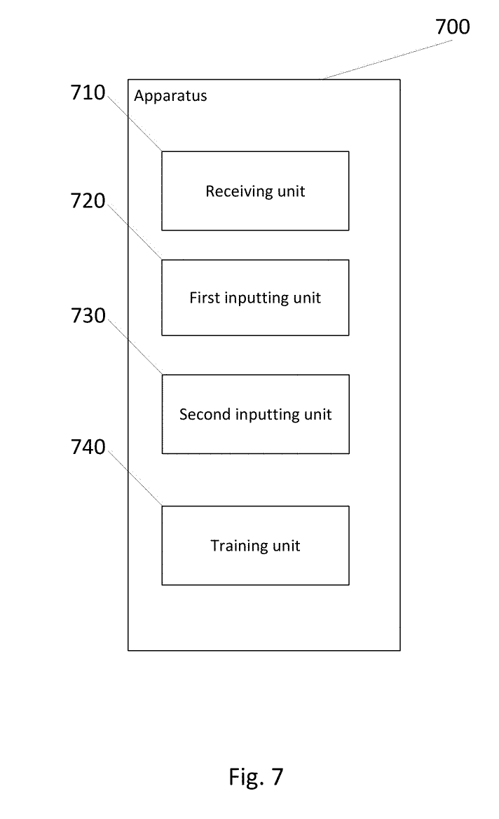

FIG. 7 illustrates an apparatus in accordance with certain embodiments of the invention. Apparatus 700 may also include a receiving unit 710 that receives patient-specific data of a patient. Apparatus 700 can also include a first inputting unit 720 that inputs the patient-specific data into an input layer of a 1D convolutional neural network. Apparatus 700 also includes a second inputting unit 730 that inputs labels corresponding to the patient-specific data into an output layer of the 1D convolutional neural network. Apparatus 700 can also include a training unit 740 that trains the 1D convolutional neural network with the inputted patient-specific data and labels. The 1D convolutional neural network is configured to detect abnormality within patient-specific data.

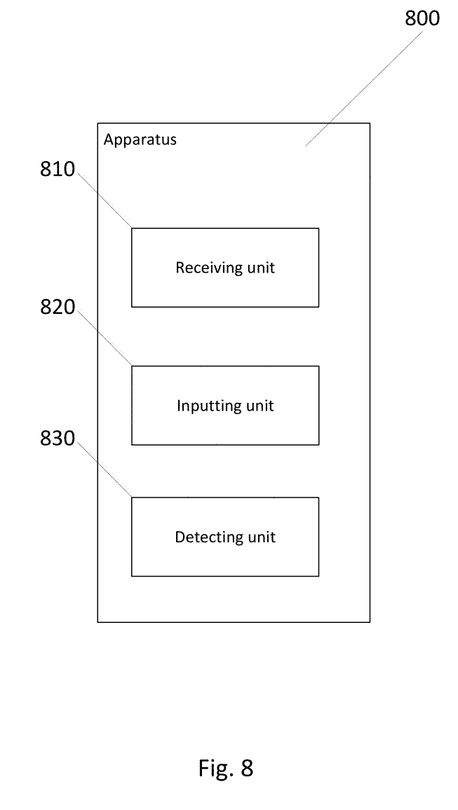

FIG. 8 illustrates an apparatus in accordance with certain embodiments of the invention. Apparatus 800 may also include a receiving unit 810 that receives patient-specific data of a patient. Apparatus 800 can also include an inputting unit 820 that inputs the patient-specific data to an input layer of a 1D convolutional neural network. The 1D convolutional neural network has been trained. Apparatus 800 can also include a detecting unit 830 that detects an abnormality within the patient-specific data using the trained 1D convolutional neural network.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving patient-specific data of a patient;
inputting the patient-specific data into an input layer of a 1D convolutional neural network;
inputting labels corresponding to the patient-specific data into an output layer of the 1D convolutional neural network; and
training the 1D convolutional neural network with the inputted patient-specific data and labels, wherein the 1D convolutional neural network is configured to detect abnormality within patient-specific data.

2. The method according to claim 1, wherein receiving patient-specific data comprises receiving electrocardiogram data of the patient.

3. The method according to claim 2, further comprising processing the received patient-specific data, wherein the processing comprises detecting beats of the electrocardiogram data, and the detecting beats comprises classifying each beat to a category.

4. The method according to claim 1, wherein configuring the 1D convolutional neural network to detect abnormality comprises configuring the 1D convolutional neural network to detect an ectopic beat.

5. The method according to claim 1, wherein the 1D convolution neural network is configured to perform a plurality of back-propagation iterations, and to update weights and bias sensitivities of the 1D convolution neural network for each back-propagation iteration.

6. The method according to claim 1, wherein training the 1D convolutional neural network comprises training using patient-specific data patterns and global data patterns, and the patient-specific data pattern comprises a duration of beats from the patient.

7. An apparatus, comprising:
at least one processor; and
at least one memory including computer program code,
the at least one memory and the computer program code configured, with the at least one processor, to cause the apparatus at least to
receive patient-specific data of a patient;
input the patient-specific data into an input layer of a 1D convolutional neural network;
input labels corresponding to the patient-specific data into an output layer of the 1D convolutional neural network; and
train the 1D convolutional neural network with the inputted patient-specific data and labels, wherein the 1D convolutional neural network is configured to detect abnormality within patient-specific data.

8. The apparatus according to claim 7, wherein receiving patient-specific data comprises receiving electrocardiogram data of the patient.

9. The apparatus according to claim 8, wherein the apparatus is further caused to process the received patient-specific data, wherein the processing comprises detecting beats of the electrocardiogram data, and the detecting beats comprises classifying each beat to a category.

10. The apparatus according to claim 7, wherein configuring the 1D convolutional neural network to detect abnormality comprises configuring the 1D convolutional neural network to detect an ectopic beat.

11. The apparatus according to claim 7, wherein the 1D convolution neural network is configured to perform a plurality of back-propagation iterations, and to update weights and bias sensitivities of the 1D convolution neural network for each back-propagation iteration.

12. The apparatus according to claim 7, wherein training the 1D convolutional neural network comprises training using patient-specific data patterns and global data patterns, and the patient-specific data pattern comprises a duration of beats from the patient.

13. A computer program embodied on a non-transitory computer readable medium, said computer readable medium having instructions stored thereon that, when executed by a computer, causes the computer to perform the method of claim 1.

14. A method, comprising:
receiving patient-specific data of a patient;
inputting the patient-specific data to an input layer of a 1D convolutional neural network, wherein the 1D convolutional neural network has been trained; and
detecting an abnormality within the patient-specific data using the trained 1D convolutional neural network.

15. The method according to claim 14, wherein receiving patient-specific data comprises receiving electrocardiogram data of the patient.

16. The method according to claim 15, further comprising processing the received patient-specific data, wherein the processing comprises detecting beats of the electrocardiogram data.

17. The method according to claim 14, wherein detecting an abnormality comprises detecting an ectopic beat.

18. The method according to claim 14, wherein the 1D convolution neural network is configured to perform a plurality of back-propagation iterations, and to update weights and bias sensitivities of the 1D convolution neural network for each back-propagation iteration.

19. The method according to claim 14, wherein the 1D convolutional neural network is trained using patient-specific data patterns and global data patterns, and the patient-specific data pattern comprises a duration of beats from the patient.

20. An apparatus, comprising:
at least one processor; and
at least one memory including computer program code,
the at least one memory and the computer program code configured, with the at least one processor, to cause the apparatus at least to
receive patient-specific data of a patient; input the patient-specific data to an input layer of a 1D convolutional neural network, wherein the 1D convolutional neural network has been trained; and
detect an abnormality within the patient-specific data using the trained 1D convolutional neural network.

21. The apparatus according to claim 20, wherein receiving patient-specific data comprises receiving electrocardiogram data of the patient.

22. The apparatus according to claim 21, wherein the apparatus is further caused to process the received patient-specific data, wherein the processing comprises detecting beats of the electrocardiogram data.

23. The apparatus according to claim 20, wherein detecting an abnormality comprises detecting an ectopic beat.

24. The apparatus according to claim 20, wherein the 1D convolution neural network is configured to perform a plurality of back-propagation iterations, and to update weights and bias sensitivities of the 1D convolution neural network for each back-propagation iteration.

25. The apparatus according to claim 20, wherein the 1D convolutional neural network is trained using patient-specific data patterns and global data patterns, and the patient-specific data pattern comprises a duration of beats from the patient.

26. A computer program embodied on a non-transitory computer readable medium, said computer readable medium having instructions stored thereon that, when executed by a computer, causes the computer to perform the method of claim 14.
